(19) United States
(12) Patent Application Publication
(10) Pub. No.: US 2025/0091761 A1
(43) Pub. Date: Mar. 20, 2025

(54) FAUX ELECTRICAL SOCKET-OUTLET

(71) Applicant: Timothy Parlor, SR., Covington, GA (US)

(72) Inventor: Timothy Parlor, SR., Covington, GA (US)

(21) Appl. No.: 18/965,092

(22) Filed: Dec. 2, 2024

Related U.S. Application Data
(62) Division of application No. 15/073,623, filed on Mar. 17, 2016.
(60) Provisional application No. 62/134,109, filed on Mar. 17, 2015.

(51) Int. Cl. B65D 6/00; H02G 3/12; H02G 3/14

(52) U.S. Cl. CPC B65D 11/10; H02G 3/12; H02G 3/14

(57) ABSTRACT

Implementations of a faux electrical socket-outlet are provided. In some implementations, a faux outlet comprises a body having a plurality of surfaces forming an enclosure; and one or more faux sockets wherein each faux socket comprises openings configured to receive the pins of a power plug, wherein the enclosure of the body is sized to house the pins of the power plug when the power plug is inserted in openings of the faux socket, and wherein the faux sockets cannot receive and cannot supply power. When the faux outlet is attached to a wall, unused power plugs or electrical devices (e.g., plug-in air fresheners) may be neatly stored and organized while not in use by inserting the power plugs in the faux outlet.

### CROSS-REFERENCE TO RELATED APPLICATIONS

This divisional patent application claims the priority benefit of U.S. patent application Ser. No. 15/073,623 (filed on Mar. 17, 2016), which claims the priority benefit of U.S. Patent Application Ser. No. 62/134,109 (filed on Mar. 17, 2015), and both U.S. patent application Ser. No. 15/073,623 and U.S. Patent Application Ser. No. 62/134,109 are incorporated herein by reference in their entireties.

### TECHNICAL FIELD

This disclosure relates to implementations of a faux electrical socket-outlet.

### BACKGROUND

U.S. Pat. No. 6,786,766 discloses an exploded view of an example electrical socket-outlet (“outlet”) (reproduced at FIG. 4) for supplying power to external electrical appliances. The outlet comprises a faceplate 13, a receptacle 11, and a box 10. The box 10 houses one or more power cables having conductors therein for supplying electricity. The conductors are electrically connected to the receptacle 11. The receptacle 11 is attached to the front of the box 10 and the faceplate 13 is attached to the receptacle 11. The faceplate 13 is dimensioned to close the opening of the box 10. The faceplate 13 includes one or more apertures to receive electrical connectors of an external electrical appliance. The '755 patent discloses that the electrical connectors are penetratingly connected to the receptacle 11 to provide power to the appliance.

Existing electrical outlets such as the example outlet disclosed in the '766 patent may be mounted on walls or other structures and connected to a power source to provide immediate access to electricity for powering external devices. It is very common to see plugs from external devices inserted into electrical outlets. Typically, when an external device is not in use and it is desirable to unplug the electrical device by removing the electrical connector from the electrical outlet, the electrical connector rests on the floor or other place not intended for the electrical connector. This can be unsightly, unsafe, and/or an obstruction.

### BRIEF DESCRIPTION OF THE DRAWINGS

FIGS. 1A-1C illustrates an example implementation of a faux electrical socket-outlet according to the present disclosure.

FIG. 2A illustrates another example implementation of a faux outlet according to the present disclosure.

FIG. 2B illustrates another example implementation of a faux outlet according to the present disclosure

FIG. 3A illustrates another example implementation of a faux outlet according to the present disclosure.

FIG. 3B illustrates another example implementation of a faux outlet according to the present disclosure.

FIG. 4 illustrates an exploded view of a prior art electrical socket-outlet configured to be energized.

### DETAILED DESCRIPTION

Implementations of a faux electrical socket-outlet are provided. In some implementations, a faux outlet comprises a body having a plurality of surfaces forming an enclosure; and one or more faux sockets wherein each faux socket comprises openings configured to receive the pins of a power plug, wherein the enclosure of the body is sized to house the pins of the power plug when the power plug is inserted in openings of the faux socket, and wherein the faux sockets cannot receive and cannot supply power. When the faux outlet is attached to a wall, unused power plugs or electrical devices (e.g., plug-in air fresheners) may be neatly stored and organized while not in use by inserting the power plugs in the faux outlet.

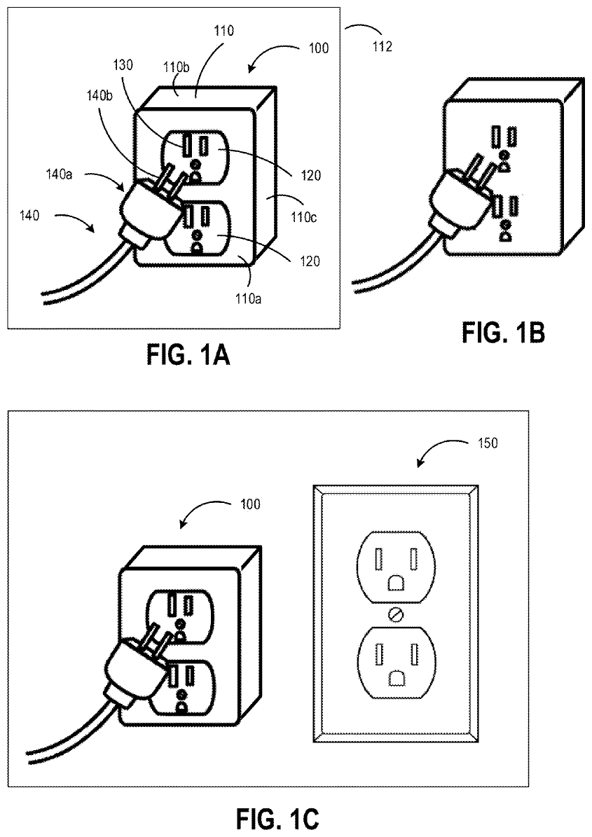

FIG. 1A illustrates an example implementation of a faux electrical socket-outlet (“outlet”) 100 according to the present disclosure. In some implementations, the outlet 100 comprises a body 110 having a plurality of surfaces forming an enclosure and a faux socket 120 (e.g., receptacle). In some implementations, the faux socket 120 is housed within the enclosure and accessible through an opening through a first surface (e.g., surface 110a) of the body 110. In some implementations, the faux socket 120 is integral with the first surface of the body 110.

In some implementations, the body 110 may have a second surface configured to attach the body 110 to an attachment surface 112 such that the faux socket 120 is accessible. In some implementations, the attachment surface 112 may be flat. In some implementations, the attachment surface may be a wall. In some implementations, the attachment surface may be a floor. In some implementations, the attachment surface may be any surface. In some implementations, the first surface and the second surface are on opposite sides of the body 110.

In some implementations, the body 110 may be in the shape of a rectangular prism having six faces/surfaces. In some implementations, the body 110 may be any shape.

In some implementations, the body 110 may be attached to a surface using an adhesive, magnets, screws, or any other attachment technology existing or developed in the future. In some implementations, the body 110 may be removably attached to a surface.

In some implementations, the faux socket 120 may be removably attached to body 110. In some implementations, the faux socket 120 is integral to the body 110. In some implementations, the faux socket 120 comprises openings 130 configured to receive electrical connectors for an external electrical device. In some implementations, an electrical connector may be a power plug (e.g., power plug 140a.) In some implementations, the power plug may be part of a power cord (e.g., power cord 140) connected to an external electrical device (not shown).

In some implementations, the faux socket 120 may be configured to receive a power plug compliant with a standard published by the National Electrical Manufacturers Association (NEMA), a national standard such as a national standard listed in the International Electrotechnical Commission (IEC) technical report TR 60083 (“Plugs and socket-outlets for domestic and similar general use standardized in member countries of IEC”), a standard published by the European Committee for Electrotechnical Standardization, or any other standard.

In some implementations, the external electrical device may be a relatively large appliance such as a washing machine or a small device such a plug-in air freshener. The external electrical device can be any size or shape. The electrical connector may be directly attached to the electrical device (e.g., in the case of a plug-in air freshener) or connected to an electrical device through a power cord, extension cord, power strip, or combination of the foregoing.

In some implementations, the faux socket 120 has a look of an existing socket and the feel of an existing socket when a plug is inserted into the socket. In some implementations, the faux socket 120 is not energized or connected to an electrical circuit for receiving power. In some implementations, the faux socket 120 is not configured to connect to an electrical circuit or to be energized. In some implementations, the faux socket 120 is a dummy socket.

In some implementations, the enclosure of the body 110 is sized to house the pins 140b of a plug 140a when the plug 140a is inserted in the socket 120. In some implementations, the body 110 has a depth from the front surface containing the socket 120 to the opposite surface to house the pins 140b of a plug 140a when the plug 140a is inserted in the socket 120.

In some implementations, the body 110 comprises a front surface 110a and a back surface (not shown) opposite the front surface 110a, a top surface 110b and a bottom surface (not shown) opposite the top surface 110b, and a right side surface 110c and a left side surface (not shown) opposite the right side surface 110c configured to form the enclosure. In some implementations, the surfaces form a rectangular prism.

In some implementations, the front surface 110a comprises one or more openings through which the openings of one or more faux sockets 120, respectively, are accessible.

As shown in FIG. 1B, in some implementations, the front surface of the body comprises openings configured to receive the pins (e.g., pins 140b) of a plug (e.g., plug 140a).

To use the faux outlet 100 to store power plugs not in use, a surface (e.g., the back surface) of the faux outlet 100 is attached to a surface (e.g., a wall) and then a power plug (e.g., plug 140a) is inserted into the faux socket (e.g., faux socket 120). In this way, unused power plugs or electrical devices (e.g., plug-in air fresheners) may be neatly stored and organized while not in use. In some implementations, an opening in a surface (e.g., a wall or floor) is not necessary (as with actual, energized outlets) to install the faux outlet 100.

As shown in FIG. 1C, in some implementations, the faux outlet 100 may be placed near, next to, or adjacent a real or energized outlet 150 to remove a power plug from the energized outlet and insert the power plug in the faux outlet when it is desired to unplug an external electrical device from the energized outlet.

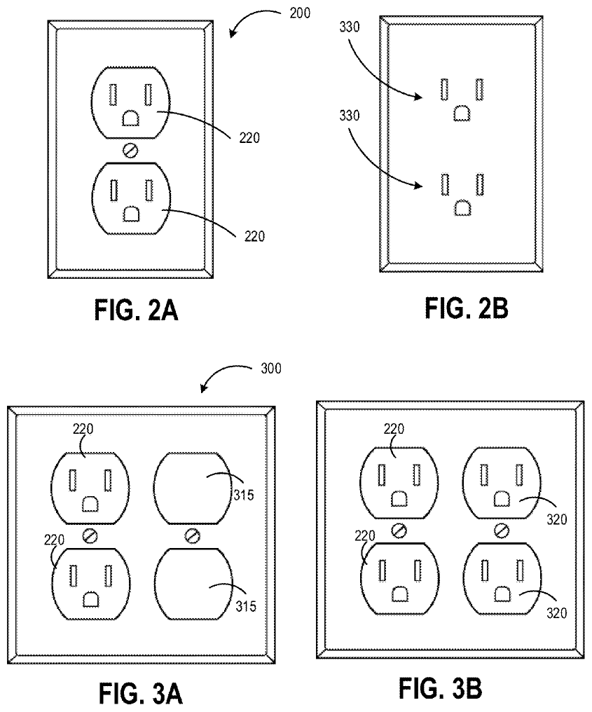

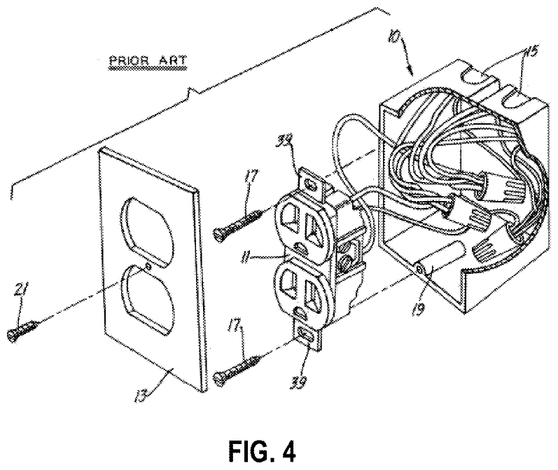

FIG. 2A illustrates another example implementation of a faux outlet 200 according to the present disclosure. In some implementations, the outlet 200 comprises a faceplate or cover 210 and one or more faux sockets 220 (e.g., receptacle). In some implementations, the faux socket 220 is attached to and housed behind the faceplate 210 and accessible through an opening through the faceplate 210. In some implementations, the faux socket 220 is removably attached to the faceplate 210. In some implementations, the faux socket 220 is integral to the faceplate 210. In some implementations, the faux socket 220 is similar to the faux socket (e.g., faux socket 120) described above. In some implementations, as shown in FIG. 2B the faceplate 210 comprises openings 330 configured to receive the pins (e.g., pins 140b) of a power plug (e.g., plug 140a).

To use the faux outlet 200 to store power plugs not in use, the outlet 200 is attached to a surface (e.g., a wall) having an opening configured to house the faux socket 220 or the pins (e.g., pins 140b) of a plug (e.g., plug 140a) when the plug is inserted in the openings of the outlet 200. The outlet 200 is attached to the surface such that the faceplate 210 covers the opening in the surface. In some implementations, the faux outlet 200 may

be used in place of an actual outlet. That is, the faceplate 210 may be used to cover an opening in a surface configured to install an actual outlet.

FIG. 3A illustrates another example implementation of a faux outlet 300 according to the present disclosure. The faux outlet 300 is similar to faux outlet 200 but with an addition opening 315 on the face plate 310 for installing an actual socket 320.

In some implementations, as shown in FIG. 3B, the faux outlet 300 includes an actual socket 320 housed behind the faceplate 310 and accessible through the opening

315 through the faceplate 310. In some implementations, the actual socket 320 is compliant with standards published by the NEMA, a national standard such as a national standard listed in the IEC technical report TR 60083 (“Plugs and socket-outlets for domestic and similar general use standardized in member countries of IEC”), standards published by the European Committee for Electrotechnical Standardization, or any other standard. In this way, once the faux outlet 300 is installed, the faux sockets 220 are adjacent energized sockets 320 to remove a power plug from an energized socket and insert the power plug in a faux socket when it is desired to unplug an external electrical device from the energized outlet.

In some implementation, once the faux outlet 300 is installed, the faux sockets 220 are indistinguishable from the energized sockets 320.

In some implementations, the faux outlets (e.g., 220, 320) may include indicia to identify the faux outlets or sockets.

In some implementations, the face plate may include a light switch (not shown).

In some implementations, the faux outlets disclosed herein may be used in a commercial, industrial, or residential setting.

In some implementations, the principles of the present disclosure can be used to store other connectors such as jacks, plugs, cables, including USB plugs, coaxial power connectors attached to a device that are desired to be unplugged from an energized receiver for the connector.

Reference throughout this specification to “an embodiment” or “implementation” or words of similar import means that a particular described feature, structure, or characteristic is included in at least one embodiment of the present invention. Thus, the phrase “in an embodiment”, “in some implementations”, or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

1. A method of using a faux outlet, the method comprising:
removably attaching or securing the faux outlet to an exterior surface of an attachment structure of an environment,
wherein the faux outlet comprises the body and at least one faux socket,
wherein the body comprises a plurality of surfaces that comprises at least a first surface and a second surface,
wherein the faux outlet in its entirety is positioned external to the exterior surface of an attachment structure when the faux outlet is removably attached or secured to the exterior surface of the attachment structure,
wherein the at least one faux socket is positioned on at least one surface of the plurality of surfaces of the body,
wherein at least one of the at least one faux socket comprises at least one opening dimensioned and configured to receive at least one pin of a power plug of a device,
wherein at least one of the at least one faux socket is not able to receive electricity or power from and is not able to transmit electricity or power to the device, and
when in use, inserting the power plug of the device into the at least one opening of the at least one faux socket.

2. The method of claim 1, wherein the faux outlet further comprises a securing element configured to removably attach the body to the exterior surface of the attachment structure.

3. The method of claim 1, wherein the at least one faux socket is a plurality of faux sockets, and wherein each faux socket of the plurality of faux sockets is not able to receive electricity or power from and is not able to transmit electricity or power to the device.

4. The method of claim 1, wherein the body of the faux outlet is removably attached or secured to the exterior surface of the attachment structure of the environment.

5. The method of claim 1, wherein the faux outlet is transportable to different locations in the environment and to different environments for use.

6. The method of claim 1, wherein the faux outlet further comprises a securing element that is selected from the group consisting of an adhesive, a magnet, and a screw.

7. A method of using a hybrid outlet, the method comprising:
removably attaching or securing the hybrid outlet to an exterior surface of an attachment structure of an environment,
wherein the hybrid outlet comprises the body, at least one faux socket, and at least one live socket,
wherein the body comprises a plurality of surfaces that comprises at least a first surface and a second surface,
wherein the hybrid outlet in its entirety is positioned external to the exterior surface of an attachment structure when the hybrid outlet is removably attached or secured to the exterior surface of the attachment structure,
wherein at least one of the at least one faux socket and the at least one live socket is positioned on at least one surface of the plurality of surfaces of the body,
wherein at least one of the at least one faux socket comprises at least one opening dimensioned and configured to receive at least one pin of a power plug of a device,
wherein the at least one faux socket is not able to receive electricity or power from and is not able to transmit electricity or power to the device;
wherein at least one of the at least one live socket comprises at least one opening dimensioned and configured to receive at least one pin of a power plug of a device,
wherein the at least one live socket is able to receive electricity or power from and is able to transmit electricity or power to the device, and
when in use, inserting the power plug of the device into one of the at least one opening of the at least one faux socket or into one of the at least one opening of the at least one live socket.

8. The method of claim 7, wherein the hybrid outlet further comprises a securing element configured to removably attach the hybrid outlet to the exterior surface of the attachment structure.

9. The method of claim 7, wherein the at least one faux socket is a plurality of faux sockets, wherein each faux socket of the plurality of faux sockets is not able to receive electricity or power from and is not able to transmit electricity or power to the device.

10. The method of claim 7, wherein the at least one live socket is a plurality of live sockets, wherein each live socket of the plurality of live sockets is able to receive electricity or power from and is able to transmit electricity or power to the device.

11. The method of claim 7, wherein the body of the hybrid outlet is removably attached or secured to the exterior surface of the attachment structure of the environment.

12. The method of claim 7, wherein the hybrid outlet is transportable to different locations in the environment and to different environments for use.

13. The method of claim 7, wherein the hybrid outlet further comprises a securing element that is selected from the group consisting of an adhesive, a magnet, and a screw.

14. A hybrid outlet for securing a power plug of an environment's electrical device present in an environment, said hybrid outlet comprising:
a body comprising a plurality of surfaces defining an enclosure,
wherein each surface of said plurality of surfaces of said body is positioned outwardly away from the exterior surface of the environment's attachment structure and directed toward the environment when said hybrid outlet is attached or secured to the exterior surface of the environment's attachment structure such that said faux outlet in its entirety is positioned external to the exterior surface of an attachment structure;
at least one faux socket positioned at one or more surface of said plurality of surfaces of said body,
wherein at least one of said at least one faux socket comprises at least one opening dimensioned and configured for receiving and securing a corresponding pin or prong of the power plug of the environment's electrical device that is present in the environment and not in use,
wherein each faux socket of said at least one faux socket is not able to receive electricity or power from the environment's electrical device and is not able to transmit electricity or power to the environment's electrical device; and
at least one live socket positioned at one or more surface of said plurality of surfaces of said body,
wherein at least one of said at least one live socket comprises at least one opening dimensioned and configured for receiving and securing a corresponding pin or prong of the power plug of the environment's electrical device that is present in the environment, and
wherein each live socket of said at least one live socket is able to receive electricity or power from the environment's electrical device and is able to transmit electricity or power to the environment's electrical device.

15. The hybrid outlet of claim 14, wherein said plurality of surfaces of said body define an enclosure, and wherein a first surface of said plurality of surfaces of said body comprises at least one of said at least one faux socket and said at least one live socket.

16. The hybrid outlet of claim 15, wherein all remaining surfaces, other than said first surface, of said plurality of surfaces of said body is a solid surface having no aperture for an object to pass through said surface if each of said all remaining surfaces does not comprise at least one faux socket that comprises at least one opening dimensioned and configured for receiving and securing a corresponding pin or prong of the power plug of the environment's electrical device.

17. The hybrid outlet of claim 14, wherein said body of said hybrid outlet is configured and adapted for being attached or secured to the exterior surface of the environment's attachment structure present in the environment.

18. The hybrid outlet of claim 14, further comprising a securing element configured to attach at least one surface of said plurality of surfaces of said body to the exterior surface of the environment's attachment structure.

19. The hybrid outlet of claim 18, wherein the securing element is selected from the group consisting of an adhesive, a magnet, and a screw.
